(19) United States
(12) Patent Application Publication
(10) Pub. No.: US 2004/0013090 A1
(43) Pub. Date: Jan. 22, 2004

(54) System and method for routing a call via a path of least resistance in a network

(76) Inventors: James P. Cashiola, Austin, TX (US); Dan Smith, (US)

Correspondence Address: Erik B. Cherdak & Associates, LLC, Suite 906, 11300 Rockville Pike, Rockville, MD, 20852, US

(21) Appl. No.: 10/199,498

(22) Filed: Jul. 22, 2002

(51) Int. Cl. H04L 12/26

(52) U.S. Cl. 370/238; 370/252; 370/389

(57) ABSTRACT

Systems and methods for facilitating routing of a call along a path of least resistance in a network based on the real-time capacity of network devices. The systems and methods are directed towards a first network device that receives a call (voice or data) to route to a destination device within the network; a plurality of in-sequence devices each configured to receive and route calls to other devices within the network, each in-sequence device having an associated capacity; and a control facility coupled to the network and configured to communicate with and control disparate devices within the network, to receive the capacity from each of in-sequence devices and to route the call from the first device to at least one of the in-sequence devices based on the capacity of at least one of the in-sequence devices, thus terminating the call at the destination device.

### BACKGROUND OF THE INVENTION

1. Field of the Invention

The present invention relates to systems and methods used to provision, control, manage, and facilitate delivery of telecommunications and computing (data) services. More particularly, the present invention relates to systems and methods used to route calls and data streams in a converging network in order to maximize the delivery performance of such calls or data streams.

2. Description of the Related Art

Commercial use of the Internet has increased both in kind and magnitude. The popularity of the Internet and World Wide Web in commerce has made network computing increasingly more important in today's environment. Many companies are making information available to the public over the Internet that previously has been unavailable. More and more companies are tying their core business systems to the Internet. And, whole industries have sprung up to support Internet commerce.

However, the increase in network traffic coupled with recent developments in the computer industry have made it more difficult to provide high quality of service for the delivery of voice and data across networks. For instance, the multi-media computer has advanced such that video conferencing and Internet telephony could now be viable means for everyday communication. However, such means of communicating, combining audio, video and possibly text, requires high volumes of data to be moved between possibly multiple users. Consequently, such computing requires more bandwidth in an increasingly crowded network environment.

Networking voice and data is not new. Techniques for routing calls within a telecommunications network are well known. Similarly, techniques for routing data within data networks are also well known. However, current techniques cannot guarantee the quality of service (e.g., bandwidth, etc.) required by modern computing and telecommunications, such as video conferencing. For example, a typical routing method over the Internet moves packets of data from a source device (or node) to a destination device based on the topological location of the destination device (e.g., using IP to determine network and device addresses, etc.). Each device upon receiving a stream of data simply directs the data to another router in the direction of the final destination until it is passed to a router that is connected to the destination device. However, this technique of routing does not typically take into consideration the capacity of the devices through which the data is passed. And, when a device operating at near capacity is handling a stream of data, it takes longer for the device to pass the data along to the next device. Furthermore, since this technique of routing does not take into consideration the capacity of the devices in a route, a quality of service cannot be guaranteed.

Accordingly, there have been optimization techniques developed to better route calls within a network. Such techniques are usually directed to producing the shortest path in a network. For example, network topology tables may be stored at each device that maintain information relating to the devices directly connected to it, to the overall network layout, etc. Such topology tables may be accessed during call initiation or amid routing in order to determine the shortest path to the destination device, or the path with lowest number of HOPS. However, these techniques do not take into consideration the capacity at which devices are operating, and although performance of the call may be increased, a quality of service for the call cannot be guaranteed.

Thus, there exists a need to provide new and improved systems and methods for routing calls in a network that maximize the performance of networks by taking a path of least resistance where the devices operating at the lowest capacity are utilized. To be viable, such new and improved systems and methods must take advantage of modern technologies such as networking technologies and processes to determine the capacity of routing devices in real-time and to control the same so as to guarantee the quality of service of the call. And, such new and improved systems and methods must facilitate provisioning and management of telecommunications services in converging telecommunications networks via the Internet and World Wide Web (WWW) (and other similar or like networks).

The present invention squarely addresses the aforementioned problems and delivers such new and improved systems and methods which are described in detail below.

### SUMMARY OF THE INVENTION

The present invention solves the aforementioned problems and provides new and improved systems and methods for integrating network resources within converging telecommunications networks to guarantee a quality of service of a call. Such systems and methods facilitate the routing of calls over voice and data networks especially over publicly accessible networks such as the Internet. Consumers of telecommunications services will benefit from the present invention by obtaining guaranteed performance.

The present invention solves the aforementioned problems and provides the above-stated benefits by providing new and improved systems and methods for facilitating routing of a call along a path of least resistance in a network based on the real-time capacity of network devices within the network. The system includes a first network device that receives a call (voice or data) to route to a destination device within the network; a plurality of in-sequence devices each configured to receive and route calls to other devices within the network, each in-sequence device having an associated capacity; and a control facility coupled to the network and configured to communicate with and control disparate devices within the network, to receive the capacity from each in-sequence device and to route the call from the first device to at least one of the in-sequence devices based on the capacity of said at least one of the in-sequence devices, thus terminating the call at the destination device.

According to another aspect of the present invention, provided is a method that facilitates the routing of calls within a network based on real-time device capacity in order to guarantee the quality of service of calls, comprising the steps of: initiating a call to a destination device within the network; selecting all candidate devices within the network through which it is possible to route the call; determining the real-time capacity of each candidate device; and routing the call within the network via a path of selected candidate devices based on the capacities of each device, terminating the call at the destination device.

And, according to another aspect of the present invention, provided is a method that facilitates the routing of calls within a network based on real-time device capacity in order to guarantee the quality of service of calls, comprising the steps of: initiating a call with in the network; selecting candidate devices within the network through which to pass the call next; determining the real-time capacity of each of the candidate devices; passing the call to the candidate device with the lowest capacity, as a current device; checking whether the current device is connected to the destination device; if the current device is not connected to the destination device, repeating the selecting, determining, passing steps until the current device is connected to the destination device; and terminating the call at the destination device.

### BRIEF DESCRIPTION OF THE DRAWING FIGURES

The present invention is described in detail below with reference to the attached drawing figures, of which:

FIG. 1A is a diagram of a system in which calls may be routed and delivered based on real-time device capacity in order to guarantee the quality of service of the calls in accordance with a preferred embodiment of the present invention;

FIG. 1B is a diagram of a subsection of the system of FIG. 1A in which calls may be routed and delivered based on real-time device capacity in order to guarantee the quality of service of the calls in accordance with a preferred embodiment of the present invention;

FIG. 2 is a block diagram of a data processing system that may be used to implement control systems, interfacing facilities, network devices and database management facilities in accordance with a preferred embodiment of the present invention;

FIG. 3A is a flow chart of a method that facilitates the routing of calls within a network based on real-time device capacity in order to guarantee the quality of service of calls in accordance with a preferred embodiment of the present invention; and

FIG. 3B is a flow chart of a second method that facilitates the routing of calls within a network based on real-time device capacity in order to guarantee the quality of service of calls in accordance with a preferred embodiment of the present invention.

### DETAILED DESCRIPTION OF THE PREFERRED EMBODIMENTS

The present invention is now discussed in detail with regard to the attached drawing figures which were briefly described above. Unless otherwise indicated, like parts and processes are referred to with like reference numerals.

For the purposes of the following discussions, the following terms are intended to have the following means:

A call means any voice or data transmission across a merged telecommunications network or data network, and can be initiated from any kind of voice or data device, such as a telephone, voice response unit, gateway, switch, personal computer, server system, router, etc.; and

A virtual private network (VPN) is a network, a converged telecommunications network or data network, wherein all devices and/or network traffic is centrally controlled.

### Structural Aspects of the Present Invention

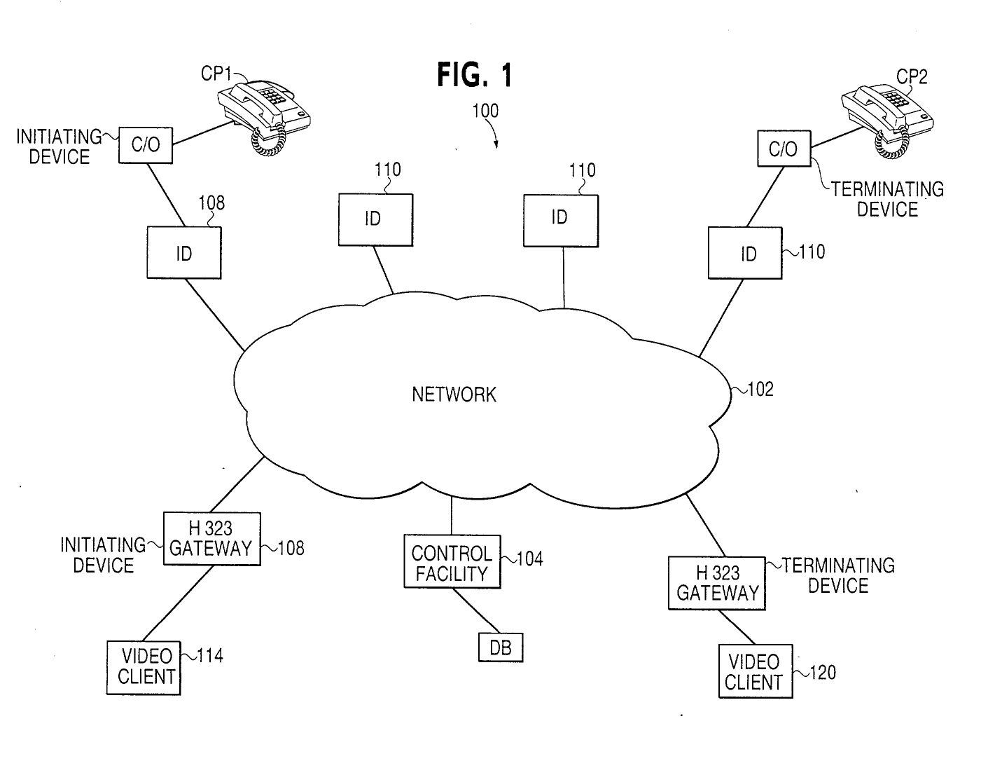

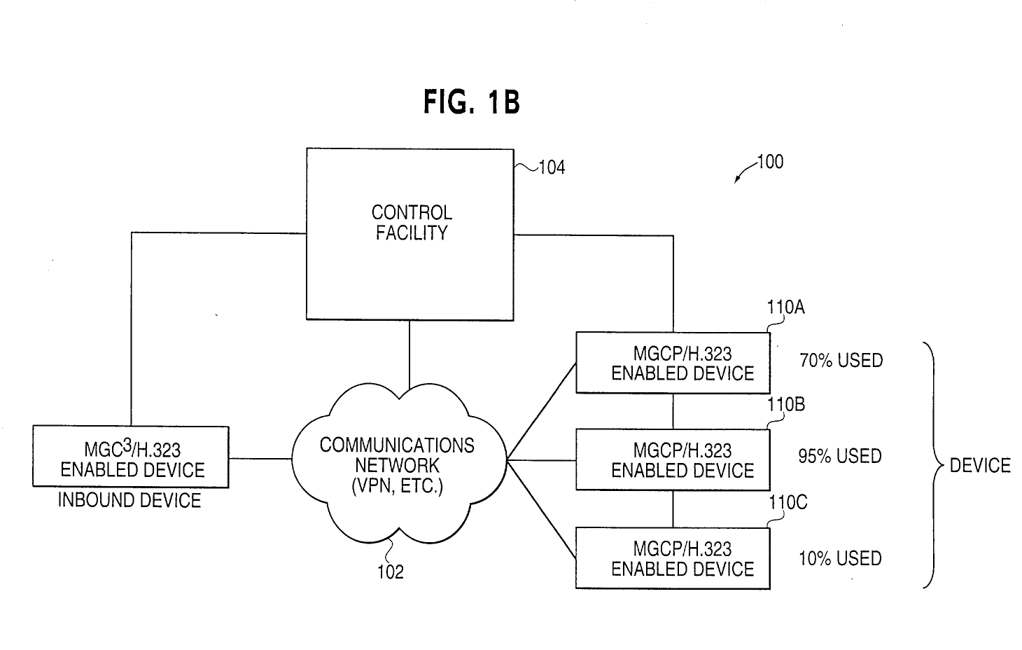

Referring now to FIG. 1A, depicted therein is a diagram of a system in which calls may be routed and delivered based on real-time device capacity in order to guarantee the quality of service of the calls in accordance with a preferred embodiment of the present invention. In particular, system 100 includes a merged telecommunications network which may include at least portions of a global network, the publicly switched telephone network (PSTN), the Internet and WWW, etc. System 100 further includes a number of devices used for initiating and delivering a call (e.g., a voice call, a data stream including video, etc.) including various routers, switches, gateways and a host of other telecommunications devices found in modern telecommunications networks and which may be accessed in merged telecommunications network 102 using a variety of modern communications protocols and device messaging schemes.

In system 100, a calling party such as calling party CP1 may utilize calling services through a central office 116 which initializes the call by routing the call to the inbound device, with may be a router or a gateway, ID 108. ID 108 would normally use a topology chart or table to identify a number of devices in the direction of the termination device based on control information which may be passed to it in the call (such as in a header portion of the call) or in a control loop (i.e., a separate Ethernet control loop). Instead, control facility 104 is configured to centrally control and track all call routing (i.e., traffic) within the entire network 102, which may be a virtual private network (VPN). Accordingly, control facility 104 receives a message (or request to route the call) from ID 108 which may contain pertinent information about the new call, such as the termination or destination device (IP address), the bandwidth requirements, delivery requirements, etc. Control facility 104 is configured to calculate a route of least resistance to the terminating device. In this case, the destination device is the central office 118, which connects the call to the called party CP2. Control facility 104 is configured to communicate with in-sequence devices 110 to determine each devices capacity in real-time, or alternatively, is configured to store and maintain real-time capacity data relating to each device with network 102, such as in database facility DB. For example, in-sequence devices 110 may be H.323 routers used to route video streams and the like, and each in-sequence device 110 may message control facility 104 its capacity in real-time using H.323, IP, etc. protocols.

After control facility 104 determines the actual real-time capacity of each in-sequence device 110, it is configured to build a path of least resistance by selecting the appropriate devices with the lowest current capacity. Since control facility 104 is also configured to control each device in the network, it can then control the in-sequence devices 110 to route the call to the termination device at the central office 116 along this calculated path.

Referring now to FIG. 1B, depicted therein is a diagram of a subsection of the system of FIG. 1A in which calls may be routed and delivered based on real-time device capacity in order to guarantee the quality of service of the calls in accordance with a preferred embodiment of the present invention. In particular, a call comes into the network, which may be a virtual private network (VPN), via inbound device 108 and may be routed next through one of the in-sequence devices, 110a, 110b, or 110c, in route to a final destination device. Control facility 104 is configured as already described above, to determine the capacity of each in-sequence device in real-time. As shown, in-sequence device 110c has the lowest current capacity of 10%. Thus, the call is routed next though in-sequence device 110c.

As shown in FIG. 1B, control facility 104 is connected to network 102 and is also connected directly to each in-sequence device in the network, thus enabling direct communication and control of each device in the network.

The operations of control facility 104 to communicate and control devices within a network are illustrated and described in detail in co-owned, co-pending U.S. patent application Ser. No. 09/414,668 entitled “SYSTEM AND METHOD FOR COMMUNICATING WITH AND CONTROLLING DISPARATE TELECOMMUNICATIONS DEVICES IN A TELECOMMUNICATIONS NETWORK,” filed on Oct. 7, 1999, which is incorporated herein by reference. Accordingly, the reader of this patent document should refer to the aforementioned co-owned, co-pending U.S. patent application for complete disclosure details related to the operations of control facility 104 in the context of communication with and control disparate devices in order to determine the capacity of devices in a network and to route a call via a path of least resistance in accordance with the present invention.

Moreover, referring back to FIG. 1A, a call in system 100 may be initiated via a device such as a video client 114 such as a system used to provide video conferencing. In such a case, video conferencing software may be used to initiate the call (e.g., via an appropriate web site or provider, etc.). Video client 114 connects to a device such as H.323 gateway 108 to deliver the video stream to another video client 120. Similar to the process described above, control facility 104 communicates with gateway 108 and determines a route of least resistance for the video stream. Control facility 104 communicates with the various in-sequence devices 110 to determine the real-time capacity of each device, or may access real-time capacity data centrally maintained and updated by control facility 104. Once the capacity of each device is determined, control facility 104 may control (reserve) the devices with the lowest capacity to route the video stream to another H.323 gateway to deliver the video stream to video client 120.

If control facility 104 is used to control each and every device within a network, then as it controls each device, it is capable of maintaining the capacity data associated with every device in the network 102 in real-time as network traffic changes. As control facility 104 initiates, routes and drops calls (or when calls are dropped naturally, such as via a failure, etc.), for example, each time an in-sequence device 110 is controlled to route a call, capacity data can be modified to reflect the increase or decrease in traffic through that device. Capacity data may be stored in a database, such as database facility DB, or cached to enhance performance.

Control facility 104 may also be configured to perform various routing algorithms to factor, for example, the shortest path or a path utilizing the best performing devices along with real-time capacity in order to build the past of least resistance. Accordingly, inventory data, including type of device, performance ratings, location, address, etc., relating to each device within network 102, may be stored locally, in database facility DB, or messaged from each device.

In the absence of control all the devices necessary to route a call, control facility 104 is configured to communication with disparate devices and determine the real-time capacity by querying capacity tables within the devices, for example, to determine it's current capacity.

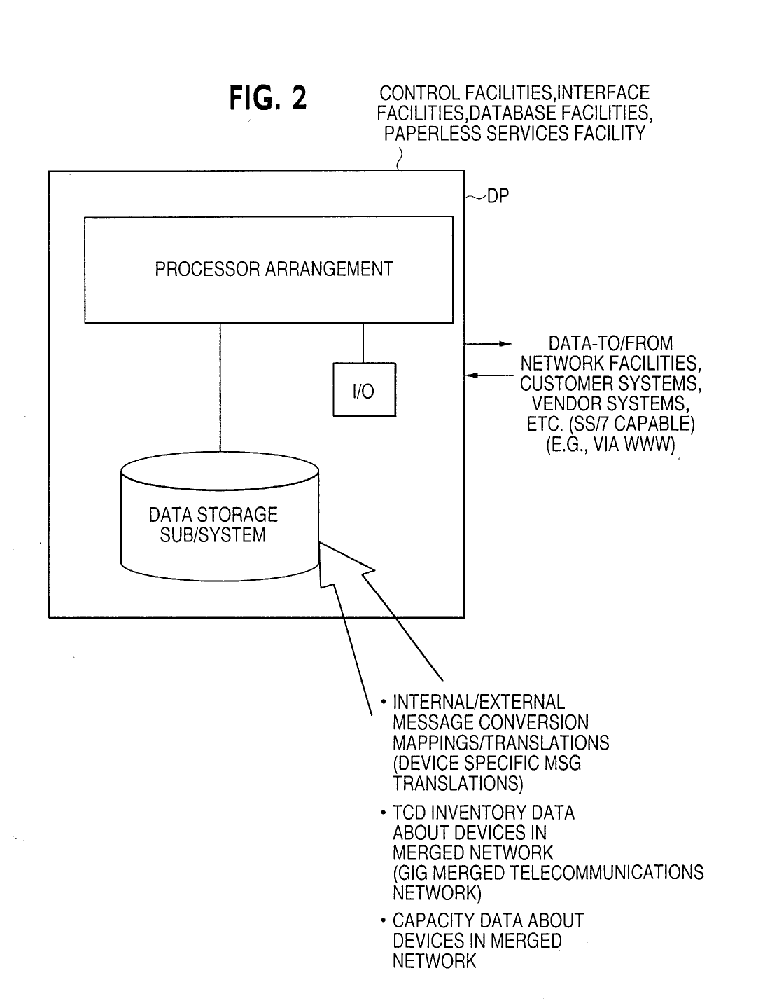

Referring now to FIG. 2, depicted therein is a block diagram of a computing system which may be used to implement control facilities, interfacing facilities, database management facilities, and network devices as described above with regard to FIG. 1 in accordance with a preferred embodiment of the present invention. In particular, FIG. 2 depicts a data processing system DP which further includes a processor arrangement 202 including one or more processing elements, a data storage subsystem 204, an 10 facility 206. The arrangement of these structures shown with data processing system DP will be immediately understood by those skilled in the art.

Data processing system DP is configured to receive and transmit data to and from network facilities and devices, customer systems, vendor systems, etc. via modern telecommunications protocols including, but not limited to, those used in SS7 out-of-band signaling systems, TCP/IP protocols, H.323 communications protocols, and any other telecommunications protocols which may used to facilitate messaging between telecommunications devices in accordance with the present invention.

Data storage subsystem 204 as shown within data processing system DP, will include internal and external messaging conversion mappings and translations, which may be used to convert device specific messages (external messages) generated by specific telecommunications devices within merged telecommunications network 102 (FIG. 1) into internal messages (IMs) which are device independent which may be used to consolidate application type data to including billing operation data etc. Data storage subsystem 204 may store and provide telecommunications device (TCD) inventory and capacity data about particular telecommunication devices in merged telecommunications network 102.

The structures described above with regard to FIGS. 1 and 2 are web enabled via open standards technology to support web based transactions and operations. Such operations need not involve traditional paper-based transactions and processes. The aforementioned and incorporated patent applications describe structure, processes, and methods which may be used to facilitate such web enabled functionality.

The present invention supports carrier class TDM technologies by Nortel, Lucent, Ericsson, Siemens, Nokia, Alcatel and Cisco and a host of others. Through MGCP and H.323, the present invention supports all IP-based products. In the context of the present invention, SS7 is fully supported.

### Operational Aspects of the Present Invention

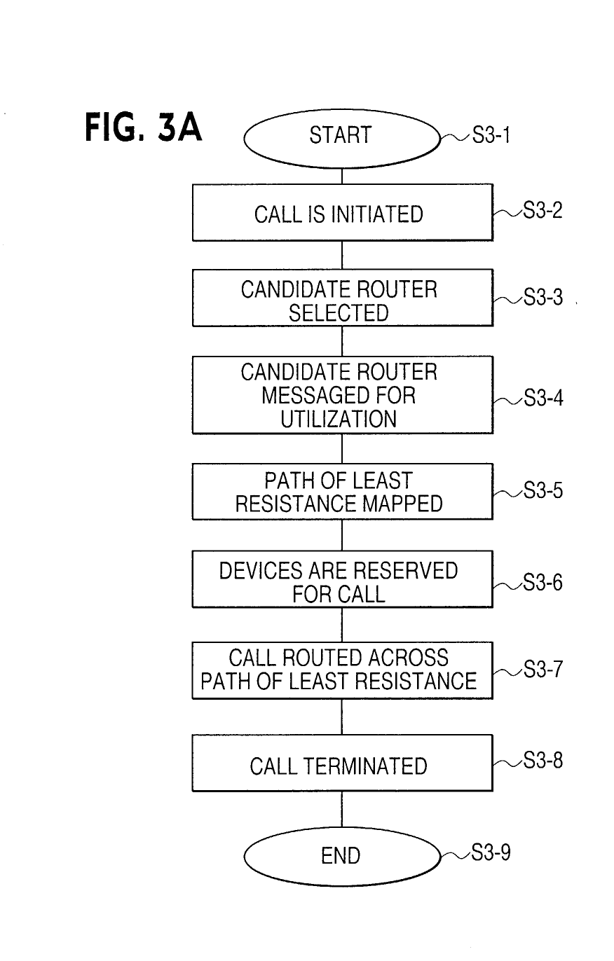

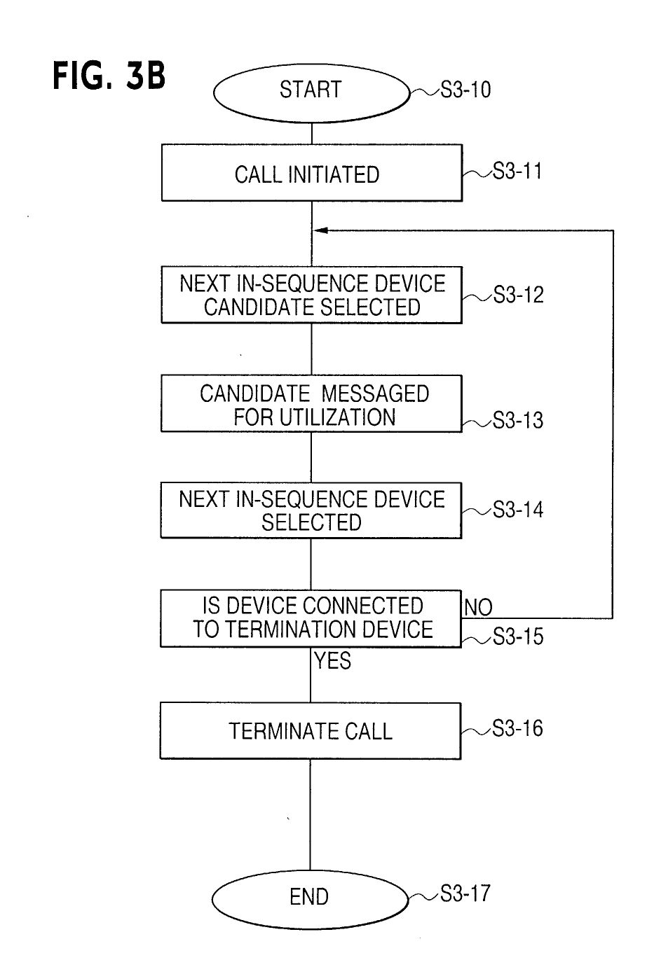

Referring now to FIG. 3A, depicted therein is a flow chart of a method that facilitates the routing of calls within a network based on real-time device capacity in order to guarantee the quality of service of calls in accordance with a preferred embodiment of the present invention. In particular, processing begins at step S3-1 and immediately proceeds to step S3-2.

At step S3-2, a call is initiated. As described above, a call could be a voice call initiated at a phone, for example, or a data call, such as a video conference initiated at some sort of video client, such as a client PC logged into a web site on the Internet and World Wide Web. The call comes into an initiating device (e.g., an H.323 gateway, etc.) within a virtual private network (VPN), where all the devices are communicated with and controlled by one control facility, such as control facility 104 described above with reference to FIG. 1. The initial device messages the control facility to alert the control facility of the call, or control facility receives a request to route a call through the VPN, or may poll devices, etc. As described above with reference to FIG. 1, the message may contain termination information, bandwidth requirements, etc. Once the call is initiated, processing proceeds next to step S3-3.

At step S3-3, candidate devices within the VPN may be selected using standard routing algorithms or techniques, such as accessing routing tables, network topology tables, etc. centrally stored or locally stored on each device. For example, all devices in the network capable of delivering the call to the termination device may be candidates.

Next, at step S3-4, the capacity of each candidate device is determined. For instance, the control facility may message each device to obtain its real-time capacity as described above, or the capacity data of every device in the VPN may be maintained centrally since every device in the VPN is controlled by the control facility. Once the capacity of all candidate devices has been determined, processing proceeds to step S3-5.

At step S3-5, the path of least resistance is selected. As described above with reference to system 100, the path of least resistance may be selected by routing the call through the devices with the lowest current capacity, or other factors may be equated, such as shortest path, performance of each device, etc. Once a route is selected, processing proceeds to step S3-6.

At step S3-6, the devices that make up the path of least resistance are reserved to route the call. As already described above, control facility is configured to control disparate telecommunications devices within a network. If the control device is maintaining the capacity of every device within the VPN, then the control device may update any centrally stored capacity data appropriately to reflect the new call and the devices utilized to route the call.

Next, at step S3-7, the call is routed, and at step S3-8, the call is terminated at the terminating device (e.g., another video conference client).

Next, at step S3-9, processing is terminated.

Referring now to FIG. 3B, depicted therein is a flow chart of a second method that facilitates the routing of calls within a network based on real-time device capacity in order to guarantee the quality of service of calls in accordance with a preferred embodiment of the present invention.

Processing begins at step S3-10 and immediately proceeds to step S3-11. At step S3-11, the call is initiated. The call may be initiated by any of the aforementioned ways described with reference to FIG. 1 or 3A. The call need not be initiated in a network in which all the devices are controlled by the same control facility. Instead, a forward-looking technique of routing is used to determine the path of least resistance. After the call is initiated, processing proceeds to step S3-12.

At step S3-12, the next in-sequence candidate devices are selected. Standard routing algorithms and techniques may be used to select the candidate devices. For example, the initial device receiving the call may access a topology table that maintains data relating to connected devices within the network to obtain a list of candidate devices. The list may be further restricted by eliminated through query restrictions, etc., devices in the wrong topological direction, for example. Once all candidate devices are selected, processing proceeds to step S3-13.

At step S3-13, each candidate's capacity is determined. This may be done, as already described above, by messaging the devices individually to determine the real-time capacity of each device or by accessing a centrally stored and maintained capacity database that is updating in real-time. An example method of centrally storing capacity data is already described above. Processing proceeds next to step S3-14.

At step S3-14, the candidate device with the lowest capacity is selected, and the call is passed to the selected device. Processing proceeds to step S3-15.

At step S3-15, it is determined whether the current device is connected to the termination or destination device (for final delivery of the call). This is determined using standard networking techniques and will be readily understood by one having ordinary skill in the art. If the device is not connected to the termination device (i.e., final destination) of the call, then processing returns to step S3-12 to determine the next set of candidate devices with the lowest current capacity, to pass the call to the next device in the network. Otherwise, the call is terminated at step S3-16.

Processing stops at step S3-17.

The advantages of this second method are that the devices need not be controlled by a single facility or entity and the path of least resistance is built during the call using the same control and communication techniques.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

For example, it should be noted that in a VPN, calls may be centrally controlled in such a way to guarantee a particular quality of service for the duration of the call by reserving a path of low resistance for the entire call duration. Once a path has been determined, the devices within the path may be reserved so that no new traffic is routed to those devices unless capacity falls below a certain predetermined threshold, etc.

What is claimed is:

1. A system for maximizing the delivery performance of a stream of data in a telecommunications network, comprising:
a first device receiving a stream of data to route to a termination device;
a plurality of in-sequence devices each configured to receive and route streams of data to other devices within said network, each said in-sequence device having an associated capacity; and
a control facility coupled to said network and configured to communicate with and control disparate devices within said network, to receive said capacity from each of said in-sequence devices and to route said stream of data from said first device to at least one of said in-sequence devices based on said capacity of said at least one of said in-sequence devices, said stream of data terminating at said terminating device.

2. The system according to claim 1, wherein each device in said plurality of in-sequence devices is controlled by said control facility.

3. The system according to claim 1, wherein said control facility is further configured to maintain capacity data associated to each device of said plurality of in-sequence devices and update said data based on real-time network traffic within said network.

4. The system according to claim 1, wherein said control facility is further configured to maintain inventory data associated to each device of said plurality of devices.

5. The system according to claim 1, wherein said at least one said in-sequence device is an H.323 enabled device.

6. The system according to claim 1, wherein said at least one said in-sequence device is an SS7 enabled device.

7. The system according to claim 1, wherein said at least one said in-sequence device is an MGCP enabled device.

8. The system according to claim 1, wherein each said in-sequence device is configured to maintain its capacity data in real-time.

9. The system according to claim 1, wherein said control facility is accessible via the Internet and World Wide Web.

10. The system according to claim 1, wherein said at least one in-sequence device has the lowest capacity out of said plurality of in-sequence devices.

11. A method for routing a call within a network with the path of least resistance comprising the steps of:
initiating a call within said network;
selecting all candidate devices within said network through which it is possible to route the call;
determining the real-time capacity of each device; and
routing the call within said network via a path of selected candidate devices based on said capacities terminating the call at a final destination.

12. The method of claim 11 wherein said capacity is centrally stored and updated within said network.

13. The method of claim 11 wherein each device within said network is centrally tracked and controlled.

14. The method of claim 11 wherein devices with the lowest capacity are selected from said candidate devices to form said path.

15. A method for routing a call to a destination device within a network via a path of least resistance comprising the steps of:
initiating a call with in said network;
selecting candidate devices within said network through which to pass the call next;
determining the real-time capacity of each said candidate device;
passing the call to the device with the lowest capacity as a current device;
checking whether said current device is connected to said destination device;
if said current device is not connected to said destination device, repeating said selecting, determining, passing steps until the current device is connected to said destination device; and
terminating said call at said destination device.

16. The method of claim 15 wherein during said determining step, the capacity of each of said candidate devices is messaged to said current device in real-time.
